(19) United States
(12) Patent Application Publication
(10) Pub. No.: US 2003/0167744 A1
(43) Pub. Date: Sep. 11, 2003

(54) Lawn hog

(76) Inventor: David Allen Quarles, Frankfort, KY (US)

Correspondence Address: David Quarles, 4121 Peaks Mill Road, Frankfort, KY, 40601, US

(21) Appl. No.: 10/091,966

(22) Filed: Mar. 7, 2002

(51) Int. Cl. A01D 75/30

(52) U.S. Cl. 56/6; 56/13.6

(57) ABSTRACT

The Lawn Hog is an inexpensive two wheeled cart acting as a spreader bar which two inexpensive push lawn mowers may be attached to. The Lawn Hog attaches to and is pulled behind a riding lawn mower and itself pulls the attached push lawn mowers, thus effectively widening the mowing swath of the riding mower.

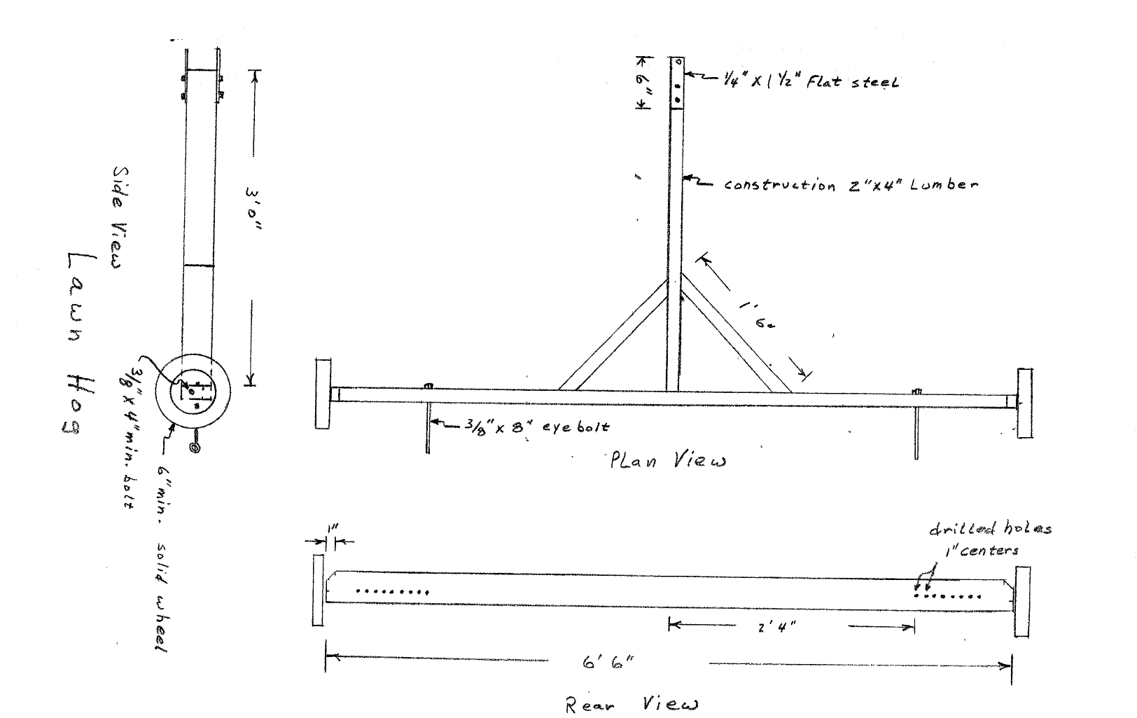

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Mowing a large lawn is hard work if a push mower is used and time consuming if a self propelled mower is used. A more expensive method is a riding lawn mower, which reduces the physical effort involved but is still time consuming. A larger riding lawn mower reduces the time but may be cost prohibitive. Even larger lawns may require a very expensive commercial type riding mower or even a farm type tractor with a mower attachment. An inexpensive alternative to reducing the work and time required to maintain a large lawn is needed.

### BRIEF SUMMARY OF THE INVENTION

A typical riding lawn mower has a mowing deck from 38 to perhaps 54 inches in width. Property owners having large lawns must spend considerable time mowing. If the property owner wishes to shorten his mowing time he must either buy a larger, more expensive riding mower or a very expensive farm type tractor large enough to drive a rotary mower (bushhog) or an even more expensive finishing mower. There are attachable mower decks that hang from the side of a riding mower but these are expensive also. The cost can be exorbitant. The Lawn Hog allows an owner to mow 44 inches (best case) of additional grass at a very affordable price.

The Lawn Hog is a spreader bar on wheeels that trails along behind the riding mower. It is much wider than the riding mower deck which allows a very inexpensive push type mower (normally 20-22 inches wide) to be attached to each end of the spreader bar. The spreader bar then tows the push mowers which cuts grass on either side of the deck of the riding mower preceding them. Thus, if the riding mower cuts a swath 44 inches wide and the two 22 inch push mowers cut a full swath, the total swath width becomes 88 inches at minimal cost to the owner.

The Lawn Hog does not include the push mowers.

### BRIEF DESCRIPTION OF THE SEVERAL VIEWS OF THE DRAWING

Plan View: This view is from an overhead view and clearly indicates the position of the braces.

Rear View: Indicates the position of the adjustment holes where the push mowers may be attached.

Side View: Indicates how the wheel and steel tongue pieces are attached.

### DETAILED DESCRIPTION OF THE INVENTION

The Lawn Hog is made of materials readily available at most lumber yards. The frame is of 2×4 construction lumber and is comprised of four pieces; spreader bar, tongue, and two braces. Each piece can be sawed with a miter saw. The pieces are assembled with common #8 screws three inches in length. The lumber is stood upright when screwed together as opposed to lying flat. In other words the frame is 3 ½ inches tall as opposed to 1 ½ inches.

The tongue is three feet long, sawed square on both ends, with one end butted up and attached to the middle of the spreader bar with #8 screws. The other end is fitted with two, six inch long, ¼ inch thick, 1 ½ inch wide, flat steel pieces. These steel pieces are drilled with two, ⅜ inch holes on one end and one ½ inch hole on the other end. five sixteenths by 1 ½ inch lag screws go through the small holes and attach the steel pieces to the 2×4. A total of four screws are used. The large hole is for the pin (by owner) to hitch the tongue to the riding mower.

The two braces are identical, sawed at 45 degree angles on both ends, and 18 inches long on the long side. Each is attached between the tongue (either side) and the spreader bar, forming the hypotenuse of a right triangle, with the tongue and spreader bar making up the other two sides of the triangle. They are attached with #8 screws.

The spreader bar is 78 inches long and square cut on both ends. One half inch diameter holes on one inch centers are drilled through the center of the 2×4 where the push mowers may be attached on either end. A ⅜ inch by 8 inch eye bolt is placed in the appropriate hole on either end of the spreader bar. The eye bolt has a nut, lock washer and flat washer on either side of the 2×4 so it can be tightened firmly into place. A clip is snapped on the eye bolt for future use in attaching the push mower to the eye bolt. Each end of the spreader bar has a six inch (minimum) diameter, ball bearing, solid steel and rubber wheel, attached to it with a ⅜ inch by 5 inch lag screw. The upper corner of the 2×4 end is cut off at a 45 degree angle to allow the wheel to spin freely without rubbing.

I claim

1. My invention is a machine used to tow ordinary push lawn mowers behind a riding mower to enable the operator to widen the swath of mowed grass.
